(19) United States
(12) Patent Application Publication
(10) Pub. No.: US 2026/0146551 A1
(43) Pub. Date: May 28, 2026

(54) HEATING ARRANGEMENT, AN EXHAUST TREATMENT SYSTEM COMPRISING THE HEATING ARRANGEMENT, A VEHICLE COMPRISING THE EXHAUST TREATMENT SYSTEM, AND A METHOD FOR A HEATING ARRANGEMENT

(71) Applicant: Traton AB, Södertälje (SE)

(72) Inventor: Ola STENLÅÅS, Hägersten (SE)

(73) Assignee: Traton AB, Södertälje (SE)

(21) Appl. No.: 19/390,029

(22) Filed: Nov. 14, 2025

(30) Foreign Application Priority Data
Nov. 22, 2024 (SE) 2451177-6

(51) Int. Cl. F01N 3/20

(52) U.S. Cl. CPC F01N 3/2066; F01N 3/2013; F01N 3/2033; F01N 3/208; F01N 2340/06

(57) ABSTRACT

A heating arrangement for an evaporator device configured downstream of a turbine rotor of a turbo device is presented. The evaporator device is configured radially inside of a turbo section of an exhaust conduit, such that a first portion of the exhaust gases flows through the evaporator device; and a second portion of the exhaust gases flows through a passage formed between an outer wall of the evaporator device and an inner wall of the exhaust conduit. The heating arrangement is configured to increase a temperature Tₑᵥₐ of a wall of the evaporator device, a temperature T_{2nd} of the second portion of the exhaust gases and/or a temperature Tₜₒₜ of the mixed first and second portions downstream of the evaporator device by utilization of one or more in the group of: an electric heating device; and/or an oxidation catalyst configured to oxidize of hydrocarbons in the passage.

### CROSS-REFERENCE TO RELATED APPLICATIONS

This application claims the benefit of priority to Swedish Application No. 2451177-6, filed on Nov. 22, 2024; the contents of which are hereby incorporated herein by reference.

### TECHNICAL FIELD

The present invention relates to heating arrangement for heating parts of an exhaust treatment system, in particular for heating an evaporator device of an exhaust treatment system. The present invention further comprises an exhaust treatment system comprising the heating arrangement, a vehicle comprising the exhaust treatment system, and a method for the heating arrangement.

The invention also relates to a computer program and a computer program product, which implement the method according to the invention.

### BACKGROUND

The following background description constitutes a description of the background to the present invention, and thus need not necessarily constitute prior art.

In connection with increased government interests concerning pollution and air quality, primarily in urban areas, emission standards and regulations regarding emissions from combustion engines have been drafted in many jurisdictions.

Such emission standards often consist of requirements defining acceptable limits of exhaust emissions from combustion engines in for example vehicles. For example, emission levels of nitrogen oxides NOₓ, hydrocarbons CₓH_{y}, carbon monoxide CO and particles PM are often regulated by such standards for most types of vehicles. Vehicles equipped with combustion engines typically give rise to such emissions in varying degrees. In this document, the invention will be described mainly for its application in vehicles, i.e. for internal combustion engines. However, the invention may be used in substantially all applications where combustion engines are used, for example in vessels such as ships or aeroplanes/helicopters.

In an effort to comply with these emission standards, the exhausts caused by the combustion of the combustion engine are treated/purified.

A common way of treating exhausts from a combustion engine comprises a so-called catalytic purification process, which is why vehicles equipped with a combustion engine usually comprise at least one catalyst. There are different types of catalysts, where the different respective types may be suitable depending on for example the combustion concept, combustion strategies and/or fuel types which are used in the vehicles, and/or the types of compounds in the exhaust stream to be purified. In relation to at least nitrous gases (nitrogen monoxide NO, nitrogen dioxide NO₂), referred to below as nitrogen oxides NOₓ, vehicles often comprise a catalyst, wherein an reductant/additive is supplied to the exhaust stream resulting from the combustion in the combustion engine, in order to reduce nitrogen oxides NOx, primarily to nitrogen gas and aqueous vapour. This is described in more detail below.

Selective catalytic reduction (SCR) catalysts are a commonly used type of catalysts for this type of reduction, primarily for heavy goods vehicles. SCR catalysts usually use ammonia NH₃, or a composition from which ammonia may be generated/formed, as a reductant to reduce the amount of nitrogen oxides NOₓ in the exhausts. The reductant, for example urea, is injected into the exhaust stream resulting from the combustion engine by a reductant dosing device arranged upstream of the catalyst. The reductant added to the catalyst is adsorbed (stored) in the catalyst, in the form of ammonia NH₃, so that a redox-reaction may occur between nitrogen oxides NOₓ in the exhausts and ammonia NH₃ available via the additive.

An evaporation device is often arranged at the reductant dosing device in order to increase the speed of the decomposition of urea into ammonia, to mix the reductant with the emissions, and/or to vaporise the reductant. The evaporation device may for example comprise a hydrolysis catalyst, possibly comprising a suitable hydrolysis coating, and/or a mixer.

When the reductant is injected into the exhaust stream, i.e. when the reductant is supplied into the exhaust treatment system, it is at least partially applied, for example as a spray, onto the evaporation device. The vaporization of the reductant and its reactions taking place on the evaporation device consumes energy. The temperature of the evaporation device is therefore reduced by the vaporization of the reductant, i.e. is reduced due to the energy consumed by the vaporization.

A reduced temperature of the evaporation device is generally unfavourable, since crystallization of the reductant may take place on the evaporation device at low temperatures. Also, puddles of reductant may be formed on the evaporation device at low temperatures. Crystallized reductant and/or liquid reductant in puddles do not mix well with the exhaust gases to be purified. Therefore, the reduced temperature of the evaporation device due to the injected reductant affects the efficiency of the downstream SCR catalysts, and thus also reduces the efficiency of the whole exhaust treatment system.

An objective of the present invention is to at least partly solve the above stated problems.

An objective of the present invention is to increase an efficiency of the exhaust treatment system.

The objective is achieved through the above mentioned heating arrangement for an evaporator device configured downstream of a turbine rotor of a turbo device. The turbo device is configured at a combustion engine to receive and interact with exhaust gases output by the combustion engine, and is connected to a downstream component of an exhaust treatment system by an exhaust conduit. The evaporator device has an annular shape and is configured radially inside of a turbo section of the exhaust conduit, such that
a first portion of the exhaust gases flows through the evaporator device and is mixed with a reductant being injected by a reductant dosing device configured radially inside the evaporator device; and
a second portion of the exhaust gases flows through a passage formed between an outer wall of the evaporator device and an inner wall of the exhaust conduit; and
the heating arrangement comprises one or more in the group of:
an electric heating device configured to increase one or more of a temperature Tₑᵥₐ of a wall of the evaporator device, a temperature T_{2nd} of the second portion of the exhaust gases, and a temperature Tₜₒₜ of a mixture of the first portion and the second portion downstream of the evaporator device by converting electric energy Eₑₗ to thermal energy Eₜₕ and providing the thermal energy Eₜₕ to the wall of the evaporator device; and
an oxidation catalyst configured at one or more parts of the outer wall of the evaporator device, and a hydrocarbon dosing device configured in the passage to inject hydrocarbons into the second portion of the exhaust gases, such that one or more of a temperature Tₑᵥₐ of a wall of the evaporator device, a temperature T_{2nd} of the second portion of the exhaust, and a temperature Tₜₒₜ of a mixture of the first portion and the second portion downstream of the evaporator device gases are increased by oxidation of the hydrocarbons at the oxidation catalyst in the passage.

Hereby, the temperature reduction of the evaporation device due to the vaporization of the reductant is mitigated or prevented. It is hereby at least partly avoided that the reductant is crystallized or forms puddles. Mixing of the reductant with the exhaust gasses is therefore considerably improved. An improved efficiency of the downstream SCR catalysts, and thus an overall improved efficiency of the whole exhaust treatment system, is hereby provided. Also, the temperature of the evaporation device may here be increased without affecting other components in the exhaust treatment system.

The electric heating device may for example be initially utilized for providing heat to the evaporation device, i.e. may be utilized when the combustion engine, the downstream SCR catalysts and/or the evaporation device are cold, such as e.g. during a cold start of the engine. The electric heating device may be quicker to provide heat to the evaporation device in those cases than the oxidation catalyst is. Also, the utilization of the electric heating device as such helps increasing the temperature of a cold combustion engine, because the load on the combustion engine is increased by the generator producing the electric power for the electric heating device. Thus, the combustion engine hereby gets warm quicker.

Then, when the temperatures of the combustion engine, the exhaust gases, the downstream SCR catalysts and/or the evaporation device have increased, the oxidation catalyst may efficiently be utilized for providing heat to the evaporation device. Thus, when the engine, the exhaust gases, the downstream SCR catalysts and/or the evaporation device are warm, the oxidation catalyst may itself provide enough heat to keep the temperature of the evaporation device at a sufficient level, because the hydrocarbons comprise a lot of energy which may efficiently be converted to heat. The oxidation of the hydrocarbons at the oxidation catalyst in the passage is then a self-sustaining exothermic oxidation, which only needs supply of the hydrocarbons to provide the heat needed.

The choice between utilizing only the electric heating device, only the oxidation catalyst, or both of the electric heating device and the oxidation catalyst for providing the heat to the evaporation device may be based on an energy optimization analysis, such that the heating of the evaporation device is optimized in terms of energy and/or an overall efficiency of the exhaust treatment system.

According to an embodiment, the annular shape of the evaporator device is formed by one or more in the group of:
a cylindric pipe; and
a cone-shaped pipe having its base in a downstream direction.

By utilization of such annular shapes for the evaporator device, the separation of the exhaust stream into the first portion and the second portion is easily achieved. Also, an evaporation of such annular shapes provides for an efficient mixing of the reductant with the exhaust gases, and therefore also for an efficient reduction of nitrogen oxides NOₓ in the downstream SCR catalysts.

According to an embodiment, the turbo section of the exhaust conduit comprises one or more in the group of:
a body of the turbo device around an outlet of the turbo device;
a portion of the exhaust conduit extending downstream at most a length L from an outlet of the turbo device, the length L being in an interval of 0 to 8 diameters D of the exhaust conduit.

By configuring the evaporator device in such a turbo section of the exhaust conduit, an efficient mixing of the reductant with the exhaust gases is provided. Hereby, an efficient reduction of nitrogen oxides NOₓ in the downstream SCR catalysts is also provided.

According to an embodiment, the evaporator device extends at least partially along the turbo section of the exhaust conduit.

The evaporator device may thus be configured to extend essentially anywhere radially inside the outlet body of the turbo device and/or up to 8 diameters D of the exhaust conduit extending downstream from the outlet of the turbo device. The evaporator device may be configured as one piece, or as two or more pieces, arranged at one part of the turbo section or distributed along the turbo section, respectively. Hereby, an efficient mixing of the reductant with the exhaust gases is provided, resulting in an efficient reduction of nitrogen oxides NOₓ in the downstream SCR catalysts. Also, this flexible implementation may be utilized in a large number of different exhaust treatment systems.

According to an embodiment, the oxidation catalyst comprises one or more in the group of:
an oxidation catalyst configured on one or more parts of the outer wall of the evaporator device; and
an oxidation catalyst configured on at least one substrate arranged in the passage and in thermal contact with the wall of the evaporator device.

Hereby, an efficient oxidation at the oxidation catalyst in the passage between the evaporator device and the exhaust conduit of the hydrocarbons being injected into the passage is provided. Heat is thereby generated and provided to the outer wall of the evaporator device and is then spread throughout the evaporator device, also to the inner wall of the evaporator device. Efficient heating of the whole evaporator device is hereby provided.

According to an embodiment, the oxidation catalyst has a surface enlarging form and comprises a catalytic coating.

Hereby, the efficiency of the oxidation of the hydrocarbons at the oxidation catalyst in the passage is improved.

According to an embodiment, the reductant dosing device is a turbo dosing device configured to distribute the reductant in an outlet of the turbo device by utilization of a rotation of the turbine rotor of the turbo device.

A turbo dosing device efficiently distributes the reductant in an outlet of the turbo device by utilization of a rotation of the turbine rotor of the turbo device. The reductant is here provided to a distribution device configured to spin together with the turbine rotor of the turbo device when exhaust gas passes through the turbine rotor, such that the reductant is efficiently mixed with the exhaust gas passing through the turbine rotor. Hereby, an efficient reduction of nitrogen oxides NOₓ in the downstream SCR catalysts is also provided.

According to an embodiment, the reductant dosing device is configured downstream of the turbo device within the turbo section of the exhaust conduit.

Hereby, the herein presented solutions are applicable on essentially any exhaust treatment system having a reductant dosing device and an evaporator device arranged in the herein defined turbo section of the exhaust conduit downstream of the turbo device.

According to an embodiment, the hydrocarbon dosing device comprises one or more in the group of:
at least one nozzle configured such that the injected hydrocarbons are prevented from reaching an inside of the evaporator device;
at least one nozzle configured in the passage;
at least two nozzles configured in the passage and distributed around a circumference of the outer wall of the evaporator device;
at least one nozzle configured at a waste gate outlet into the passage;
at least one nozzle connected to one or more annular distribution channels configured to distribute hydrocarbon to the at least one nozzle; and
at least one nozzle connected to one or more distribution channels configured to distribute hydrocarbon to the at least one nozzle, each distribution channel comprising at least one circular section.

Various nozzle configurations may be utilized for the herein presented solutions, which make them flexible and possible to implement in a large number of applications and exhaust treatment systems.

According to an embodiment, the heating arrangement comprises all of the electric heating device, the oxidation catalyst, and the hydrocarbon dosing device.

Hereby, both of the electric heating device and the oxidation catalyst may be used for preventing the evaporation device from being cold, such that an energy optimization may be provided. For example, the electric heating device may be used for heating the oxidation catalyst arranged on or in thermal contact with the evaporation device to improve its efficiency. When the temperature of the oxidation catalyst is increased by the electric heating device, it may be ensured that the oxidation catalyst has a temperature above a light-off temperature for the hydrocarbons, for example 200-250° C. Hereby, an efficient heating of the evaporator device is provided by the oxidation catalyst, since the oxidation of the hydrocarbons at the oxidation catalyst is ensured to be efficient.

According to an embodiment, the heating arrangement is configured to increase one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the electric heating device in one or more situations in the group of:
when a temperature T_{eng} of the combustion engine is below an engine temperature threshold T_{eng}_{_{_}}ₜₕ; T_{eng}<T_{eng}_{_{_}}ₜₕ;
when a temperature T_{SCR} of a selective catalytic reduction catalyst of the exhaust treatment system is below a catalyst temperature threshold T_{SCR}_{_{_}}ₜₕ; T_{SCR}<T_{SCR}_{_{_}}ₜₕ;
when the temperature Tₑᵥₐ of the wall of the evaporator device is below an evaporator temperature threshold Tₑᵥₐ_{_{_}}ₜₕ; Tₑᵥₐ<Tₑᵥₐ_{_{_}}ₜₕ;
when a temperature Tₒₓ of the oxidation catalyst is below an oxidation catalyst temperature threshold Tₒₓ_{_{_}}ₜₕ; Tₒₓ<Tₒₓ_{_{_}}ₜₕ;
when the temperature T_{2nd} of the second portion of the exhaust gases is below a second portion temperature threshold T_{2nd}_{_{_}}ₜₕ; T_{2nd}<T_{2nd}_{_{_}}ₜₕ;
when the temperature Tₜₒₜ of the mixture of the first portion and the second portion downstream of the evaporator device is below a total temperature threshold Tₜₒₜ_{_{_}}ₜₕ; Tₜₒₜ<Tₜₒₜ_{_{_}}ₜₕ; and
when a load on the combustion engine decreases.

Thus, the electric heating device is utilized for providing heat to the evaporation device when the combustion engine, the exhaust gases, the downstream SCR catalysts and/or the evaporation device are cold. The electric heating device may be quicker to provide heat to the evaporation device in those cases than the oxidation catalyst is. Also, the utilization of the electric heating device as such helps increasing the temperature of a cold combustion engine, because the load on the combustion engine is increased by the generator producing the electric power for the electric heating device. Thus, the combustion engine hereby gets warm quicker. The engine temperature threshold T_{eng}_{_{_}}ₜₕ, the catalyst temperature threshold T_{SCR}_{_{_}}ₜₕ, evaporator temperature threshold Tₑᵥₐ_{_{_}}ₜₕ, the oxidation catalyst temperature threshold Tₒₓ_{_{_}}ₜₕ, the second portion temperature threshold T_{2nd}_{_{_}}ₜₕ and/or the total temperature threshold Tₜₒₜ_{_{_}}ₜₕ may here be chosen such that the heating of the evaporation device is optimized in terms of energy and/or an overall efficiency of the exhaust treatment system. The temperature T_{SCR} of a selective catalytic reduction catalyst may in this document be a temperature of an upstream/initial section of the selective catalytic reduction catalyst, may be a temperature of an middle section of the selective catalytic reduction catalyst, may be a temperature of a downstream/final section of the selective catalytic reduction catalyst, and/or may be average or median temperature value based on one or more of the temperatures of the upstream/initial section, the middle section and/or the downstream/final section of the selective catalytic reduction catalyst. Hereby, suitable available temperature sensors and/or models may be utilized to determine the temperature T_{SCR} of a selective catalytic reduction catalyst.

According to an embodiment, the heating arrangement is configured to increase one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the oxidation of the hydrocarbons at the oxidation catalyst in one or more situations in the group of:
when a temperature T_{eng} of the combustion engine is equal to or above an engine temperature threshold T_{eng}_{_{_}}ₜₕ; T_{eng}≥T_{eng}_{_{_}}ₜₕ;
when a temperature T_{SCR} of a selective catalytic reduction catalyst of the exhaust treatment system is equal to or above a catalyst temperature threshold T_{SCR}_{_{_}}ₜₕ; T_{SCR}≥T_{SCR}_{_{_}}ₜₕ; and
when the temperature Tₑᵥₐ of the wall of the evaporator device is equal to or above an evaporator temperature threshold Tₑᵥₐ_{_{_}}ₜₕ; Tₑᵥₐ≥Tₑᵥₐ_{_{_}}ₜₕ;
when a temperature Tₒₓ of the oxidation catalyst is equal to or above an oxidation catalyst temperature threshold Tₒₓ_{_{_}}ₜₕ; Tₒₓ≥Tₒₓ_{_{_}}ₜₕ; and
when the temperature T_{2nd} of the second portion of the exhaust gases is equal to or above a second portion temperature threshold T_{2nd}_{_{_}}ₜₕ; T_{2nd}≥T_{2nd}_{_{_}}ₜₕ; and
when the temperature Tₜₒₜ of the mixture of the first portion and the second portion downstream of the evaporator device is equal to or above a total temperature threshold Tₜₒₜ_{_{_}}ₜₕ; Tₜₒₜ≥Tₜₒₜ_{_{_}}ₜₕ.

Thus, the oxidation catalyst is utilized for providing heat to the evaporation device when the temperature of the combustion engine, the exhaust gases, the downstream SCR catalysts and/or the evaporation device have increased. The oxidation catalyst may then efficiently be utilized for providing enough heat to keep the temperature of the evaporation device at a sufficient level. The engine temperature threshold T_{eng}_{_{_}}ₜₕ, the catalyst temperature threshold T_{SCR}_{_{_}}ₜₕ, evaporator temperature threshold Tₑᵥₐ_{_{_}}ₜₕ, the oxidation catalyst temperature threshold Tₒₓ_{_{_}}ₜₕ, the second portion temperature threshold T_{2nd}_{_{_}}ₜₕ, and/or the total temperature threshold Tₜₒₜ_{_{_}}ₜₕ may here be chosen such that the heating of the evaporation device is optimized in terms of energy and/or an overall efficiency of the exhaust treatment system.

According to an embodiment,
the exhaust treatment system comprises a first selective catalytic reduction catalyst and a second selective catalytic reduction catalyst arranged downstream of the first selective catalytic reduction catalyst; and
the reductant dosing device, the evaporator device, and the heating arrangement are configured upstream of the first selective catalytic reduction catalyst.

The first upstream and the second downstream selective catalytic reduction catalysts may be optimized individually, and with consideration of the entire exhaust treatment system's function, which may result in an very efficient purification of the exhausts. This individual optimization may also be used to reduce one or several of the volumes taken up by the first upstream and second downstream selective catalytic reduction catalyst, such that a compact exhaust treatment system is obtained. Hereby, a flexible exhaust treatment system is provided, which efficiently reduces the nitrogen oxides NOₓ in the exhaust stream.

According to an embodiment,
the exhaust treatment system comprises one selective catalytic reduction catalyst; and
the reductant dosing device, the evaporator device, and the heating arrangement are configured upstream of the selective catalytic reduction catalyst.

Hereby, a compact, low-complexity and efficient exhaust treatment system is provided. Such exhaust treatment systems are installed in many vehicles of today, wherefore the herein presented solutions may be implemented in many of those existing vehicles.

The above-mentioned objective is achieved also through the above-mentioned exhaust treatment system comprising:
an evaporator device; and
a herein described heating arrangement.

The exhaust treatment system has corresponding advantages as stated above for the heating arrangement.

The above-mentioned objective is achieved also through the above-mentioned vehicle comprising:
a combustion engine;
a herein described exhaust treatment system.

The vehicle has corresponding advantages as stated above for the heating arrangement.

The above-mentioned objective is achieved also through the above-mentioned method for heating an evaporator device configured downstream of a turbine rotor of a turbo device; wherein
the turbo device is configured at a combustion engine to receive and interact with exhaust gases output by the combustion engine, and is connected to a downstream component of an exhaust treatment system by an exhaust conduit; and
the evaporator device has an annular shape and is configured radially inside of a turbo section of the exhaust conduit, such that
a first portion of the exhaust gases flows through the evaporator device and is mixed with a reductant being injected by a reductant dosing device configured radially inside the evaporator device; and
a second portion of the exhaust gases flows through a passage formed between an outer wall of the evaporator device and an inner wall of the exhaust conduit;
the method comprising one or more steps in the group of:
increasing one or more of a temperature Tₑᵥₐ of a wall of the evaporator device, a temperature T_{2nd} of the second portion of the exhaust gases, and a temperature Tₜₒₜ of a mixture of the first portion and the second portion downstream of the evaporator device by utilization of an electric heating device being configured to convert electric energy Eₑₗ to thermal energy Eₜₕ and to provide the thermal energy Eₜₕ to the wall of the evaporator device; and
increasing one or more of a temperature Tₑᵥₐ of the a wall of the evaporator device, a temperature T_{2nd} of the second portion of the exhaust gases, and a temperature Tₜₒₜ of a mixture of the first portion and the second portion downstream of the evaporator device by utilization of an oxidation catalyst configured at one or more parts of the outer wall of the evaporator device, and a hydrocarbon dosing device configured in the passage to inject hydrocarbons into the second portion of the exhaust gases, such that the hydrocarbons are oxidized at the oxidation catalyst in the passage.

The method may be performed by a herein described control unit. The method has corresponding advantages as stated above for the heating arrangement.

According to an embodiment, the increase of one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the electric heating device is performed in one or more situations in the group of:
when a temperature T_{eng} of the combustion engine is below an engine temperature threshold T_{eng}_{_{_}}ₜₕ; T_{eng}<T_{eng}_{_{_}}ₜₕ;
when a temperature T_{SCR} of a selective catalytic reduction catalyst of the exhaust treatment system is below a catalyst temperature threshold T_{SCR}_{_{_}}ₜₕ; T_{SCR}<T_{SCR}_{_{_}}ₜₕ;
when the temperature Tₑᵥₐ of the wall of the evaporator device is below an evaporator temperature threshold Tₑᵥₐ_{_{_}}ₜₕ; Tₑᵥₐ<Tₑᵥₐ_{_{_}}ₜₕ;
when a temperature Tₒₓ of the oxidation catalyst is below an oxidation catalyst temperature threshold Tₒₓ_{_{_}}ₜₕ; Tₒₓ<Tₒₓ_{_{_}}ₜₕ;
when the temperature T_{2nd} of the second portion of the exhaust gases is below a second portion temperature threshold T_{2nd}_{_{_}}ₜₕ; T_{2nd}<T_{2nd}_{_{_}}ₜₕ;
when the temperature Tₜₒₜ of the mixture of the first portion and the second portion downstream of the evaporator device is below a total temperature threshold Tₜₒₜ_{_{_}}ₜₕ; Tₜₒₜ<Tₜₒₜ_{_{_}}ₜₕ; and
when a load on the combustion engine decreases.

The electric heating device is thus utilized for providing heat to the evaporation device when the combustion engine, the exhaust gases, the downstream SCR catalysts and/or the evaporation device are cold. The electric heating device may be quicker to provide heat to the evaporation device in those cases than the oxidation catalyst is. Also, the utilization of the electric heating device as such helps increasing the temperature of a cold combustion engine because the load on the combustion engine is increased by the generator producing the electric power for the electric heating device. Thus, the combustion engine hereby gets warm quicker. The engine temperature threshold T_{eng}_{_{_}}ₜₕ, the catalyst temperature threshold T_{SCR}_{_{_}}ₜₕ, evaporator temperature threshold Tₑᵥₐ_{_{_}}ₜₕ, the oxidation catalyst temperature threshold Tₒₓ_{_{_}}ₜₕ, the second portion temperature threshold T_{2nd}_{_{_}}ₜₕ and/or the total temperature threshold Tₜₒₜ_{_{_}}ₜₕ may here be chosen such that the heating of the evaporation device is optimized in terms of energy and/or an overall efficiency of the exhaust treatment system.

According to an embodiment, the increase of one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the oxidation of the hydrocarbons at the oxidation catalyst is performed in one or more situations in the group of:
when a temperature T_{eng} of the combustion engine is equal to or above an engine temperature threshold T_{eng}_{_{_}}ₜₕ; T_{eng}≥T_{eng}_{_{_}}ₜₕ;
when a temperature T_{SCR} of a selective catalytic reduction catalyst of the exhaust treatment system is equal to or above a catalyst temperature threshold T_{SCR}_{_{_}}ₜₕ; T_{SCR}≥T_{SCR}_{_{_}}ₜₕ; and
when the temperature Tₑᵥₐ of the wall of the evaporator device is equal to or above an evaporator temperature threshold Tₑᵥₐ_{_{_}}ₜₕ; Tₑᵥₐ≥Tₑᵥₐ_{_{_}}ₜₕ;
when a temperature Tₒₓ of the oxidation catalyst is equal to or above an oxidation catalyst temperature threshold Tₒₓ_{_{_}}ₜₕ; Tₒₓ≥Tₒₓ_{_{_}}ₜₕ;
when the temperature T_{2nd} of the second portion of the exhaust gases is equal to or above a second portion temperature threshold T_{2nd}_{_{_}}ₜₕ; T_{2nd}≥T_{2nd}_{_{_}}ₜₕ; and
when the temperature Tₜₒₜ of the mixture of the first portion and the second portion downstream of the evaporator device is equal to or above a total temperature threshold Tₜₒₜ_{_{_}}ₜₕ; Tₜₒₜ≥Tₜₒₜ_{_{_}}ₜₕ.

The oxidation catalyst is thus utilized for providing heat to the evaporation device when the temperature of the combustion engine, the exhaust gases, the downstream SCR catalysts and/or the evaporation device have increased. The oxidation catalyst may then efficiently be utilized for providing enough heat to keep the temperature of the evaporation device at a sufficient level. The engine temperature threshold T_{eng}_{_{_}}ₜₕ, the catalyst temperature threshold T_{SCR}_{_{_}}ₜₕ, evaporator temperature threshold Tₑᵥₐ_{_{_}}ₜₕ, the oxidation catalyst temperature threshold Tₒₓ_{_{_}}ₜₕ, the second portion temperature threshold T_{2nd}_{_{_}}ₜₕ and/or the total temperature threshold Tₜₒₜ_{_{_}}ₜₕ may here be chosen such that the heating of the evaporation device is optimized in terms of energy and/or an overall efficiency of the exhaust treatment system.

The above-mentioned objective is also achieved through the above-mentioned computer program and computer program product.

The computer program and computer program product, respectively, has corresponding advantages as stated above for the heating arrangement.

### BRIEF LIST OF FIGURES

The invention will be illustrated in more detail below, along with the enclosed drawings, where similar references are used for similar parts, and where:

FIG. 1 shows an example vehicle which may comprise an exhaust treatment system according to various embodiments of the present invention,

FIG. 2 shows an example of an exhaust treatment system in which aspects and embodiments of the present invention may be implemented,

FIG. 3 shows an example of an exhaust treatment system in which aspects and embodiments of the present invention may be implemented,

FIG. 4 shows a part of turbo device, an exhaust conduit and an exhaust treatment system, in which aspects and embodiments of the present invention may be implemented,

FIG. 5a shows a part of turbo device, an exhaust conduit and an exhaust treatment system, in which aspects and embodiments of the present invention may be implemented,

FIG. 5b shows a part of turbo device, an exhaust conduit and an exhaust treatment system, in which aspects and embodiments of the present invention may be implemented,

FIG. 5c shows a part of turbo device, an exhaust conduit and an exhaust treatment system, in which aspects and embodiments of the present invention may be implemented,

FIG. 5d shows a part of turbo device, an exhaust conduit and an exhaust treatment system, in which aspects and embodiments of the present invention may be implemented,

FIG. 6 shows a flow chart for the method for for heating an evaporator device according to the invention, and

FIG. 7 shows a control device according to the present invention.

### DETAILED DESCRIPTION

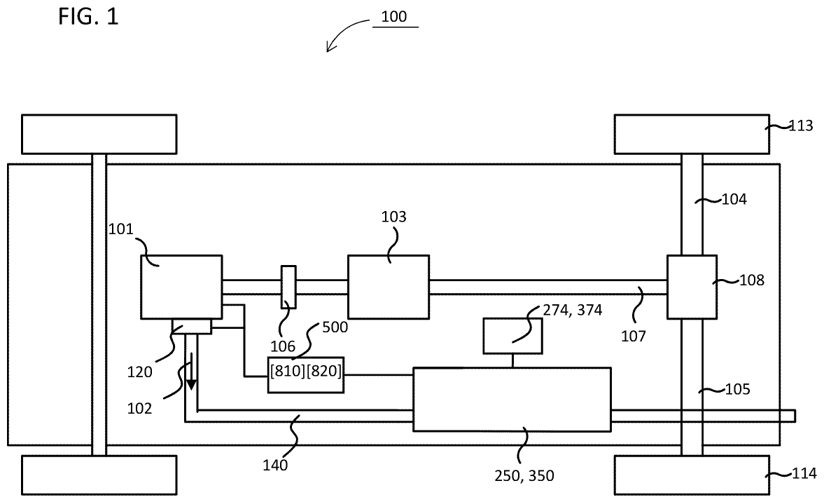

FIG. 1 schematically shows an example vehicle 100 comprising an exhaust treatment system 250, 350, which may be a herein described exhaust treatment system 250, 350. The powertrain comprises a combustion engine 101, which in a customary manner, via an output shaft of the combustion engine 101 is connected to a gearbox 103 via a clutch 106. An output shaft from the gearbox 103 may drive the wheels 113, 114 e.g. via a final drive 108, such as e.g. a customary differential, and the drive shafts 104, 105 connected to the final drive 108.

A turbo device 120 is configured at the combustion engine 101 to increase the performance and/or the fuel efficiency of the combustion engine 101. One type of turbo device 120 is a turbocharger. A turbocharger comprises a turbine rotor and a compressor, wherein the turbine rotor is driven by exhaust gas 102 output from the combustion engine 101 to power the compressor. The compressor forces air to an air inlet of the combustion engine 101 which allows more fuel to be added and hence higher power output of the combustion engine 101. A turbocharger is an efficient means of supercharging a combustion engine 101, since it utilizes energy of the exhaust gas 102 from the combustion engine 101 to compress the inlet air to the combustion engine 101.

Another type of turbo device 120 is a turbo compound. A turbo compound also comprises a turbine rotor driven by exhaust gas 102 output from the combustion engine 101. The energy recovered from the exhaust gas 102 is here sent to an output shaft of the combustion engine or is used for another purpose, such as powering an electric generator, or the like. The produced electricity can be used to produce motive power to the vehicle 100 in an electric machine or can be used to power one or more other subsystems of the vehicle 100. A turbo compound is an efficient means of increasing the total fuel efficiency since it is capable of converting part of the energy of the exhaust gas 102 into useful energy.

The combustion engine 101, e.g. an internal combustion engine, may be controlled by the engine's control system via a control unit/device 500. Likewise, the clutch 106 and the gearbox 103 may be controlled by the vehicle's control system, with the help of one or more applicable control units/devices (not shown). Naturally, the vehicle's powertrain may also be of another type, such as a type with a conventional automatic gearbox, or a type with a hybrid driveline, etc.

The vehicle 100 also comprises an exhaust treatment/purification system 250, 350 for treatment/purification of exhaust emissions resulting from combustion in the combustion chamber of the combustion engine 101.

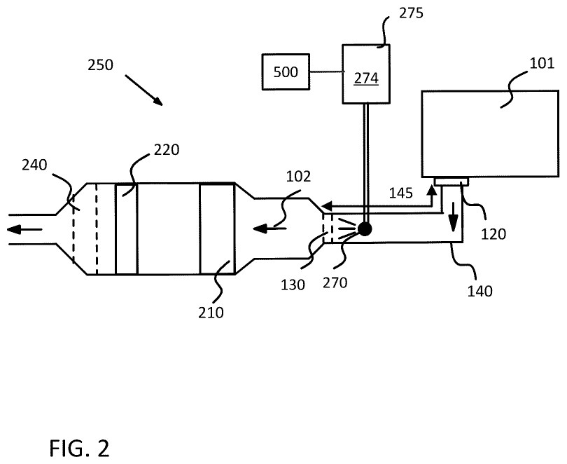

FIG. 2 shows an exhaust treatment system 250, which may illustrate a so-called Euro VI-system. The exhaust treatment system 250 is connected to a combustion engine 101, e.g. an internal combustion engine, via a turbo device 120 and an exhaust conduit 140, wherein the exhausts generated at the combustion, that is to say the exhaust stream 102, is indicated with arrows. The exhaust stream 102 is led to a coated diesel particulate filter (cDPF) 210, which is coated with a catalytically oxidizing coating, for example comprising at least one precious metal. Alternatively, a diesel oxidation catalyst (DOC) followed downstream by an uncoated diesel particulate filter (DPF) may be arranged in the exhaust treatment system 250 instead of the coated diesel particulate filter. Thus, either of a coated diesel particulate filter 210 and a diesel oxidation catalyst followed by a diesel particulate filter is arranged downstream of the combustion engine 201 in the exhaust treatment system 250.

During the combustion in the combustion engine 101, soot and ash are created, and the coated diesel particulate filter 210, or alternatively the diesel particulate filter, is used to catch the soot and ash. The exhaust stream 102 is here led through a filter structure, wherein soot and ash from the exhaust stream 102 are caught when passing through, and are stored in the particulate filter 210.

The catalytic coating in the coated diesel particulate filter 210, or alternatively in the oxidation catalyst, has several functions and is normally used primarily to oxidize, during the exhaust treatment, remaining hydrocarbons CₓH_{y} (also referred to as HC) and carbon monoxide CO in the exhaust stream 102 into carbon dioxide CO₂ and water H₂O. Also, a large fraction of the nitrogen monoxides NO occurring in the exhaust stream may be oxidized into nitrogen dioxide NO₂. The oxidation of nitrogen monoxide NO into nitrogen dioxide NO₂ is important to the nitrogen dioxide-based soot and ash oxidation in the filter, and is also advantageous at a potential subsequent reduction of nitrogen oxides NOₓ.

In this respect, the exhaust treatment system 250 further comprises a selective catalytic reduction (SCR) catalyst 220 arranged downstream of the coated diesel particulate filter 210, or alternatively downstream of the diesel oxidation catalyst followed by the diesel particulate filter. The selective catalytic reduction catalyst 220 uses ammonia NH₃, or a composition from which ammonia may be generated/formed, e.g. urea, as a reductant/additive 274 for the reduction of nitrogen oxides NOₓ in the exhaust stream 102.

After passing through the components of the exhaust treatment system, the exhaust stream is emitted into the environment at the tailpipe.

The reaction rate of this reduction is impacted by the ratio between nitrogen monoxide NO and nitrogen dioxide NO₂ in the exhaust stream, so that the reductive reaction is impacted in a positive direction by the previous oxidation of NO into NO₂ in the coated diesel particulate filter, or alternatively in the oxidation catalyst.

The reduction catalyst arrangement 220 requires reductant to reduce the concentration of a compound, such as for example nitrogen oxides NOₓ, in the exhaust stream 102. Such reductant is injected into the exhaust stream 102 upstream of the particulate filter 210 and the selective catalytic reduction catalyst 220 by a reductant dosing device 270 shown in FIG. 2. The reductant 274 is stored in a tank 275, and the injection into the exhaust stream 102 by the dosing device 270 is controlled by a control unit 500. For example, the control unit 500 may here control one or more pumps.

Such reductant is often ammonia and/or urea based, or consists of a substance from which ammonia may be extracted or released, and may for example consist of AdBlue, which basically consists of urea mixed with water. Urea forms ammonia at heating (thermolysis) and at heterogeneous catalysis on an oxidizing surface (hydrolysis), which surface may, for example, consist of titanium dioxide TiO2, within the selective catalytic reduction catalyst 220.

An evaporation arrangement 130, which is described in detail below, e.g. a hydrolysis catalyst, which may comprise substantially any suitable hydrolysis coating, and/or a mixer, is arranged at the dosing device 270 to increase the speed of the decomposition of urea into ammonia, and/or to mix the reductant with the emissions, and/or to vaporise the reductant.

The exhaust treatment system 250 may also be equipped with a slip-catalyst (SC) 240, which is arranged downstream of the selective catalytic reduction catalyst 220 to oxidize an excess of ammonia that may remain after the selective catalytic reduction catalyst 220, an/or to assist the selective catalytic reduction catalyst 220 with further reduction of NOₓ. Accordingly, the slip-catalyst SC 240 may provide a potential for improving the system's total conversion/reduction of NOₓ.

The exhaust treatment system 250 may also be equipped with one or several sensors, such as one or several NOₓ and/or temperature sensors for the determination of nitrogen oxides and/or temperatures in the exhaust treatment system.

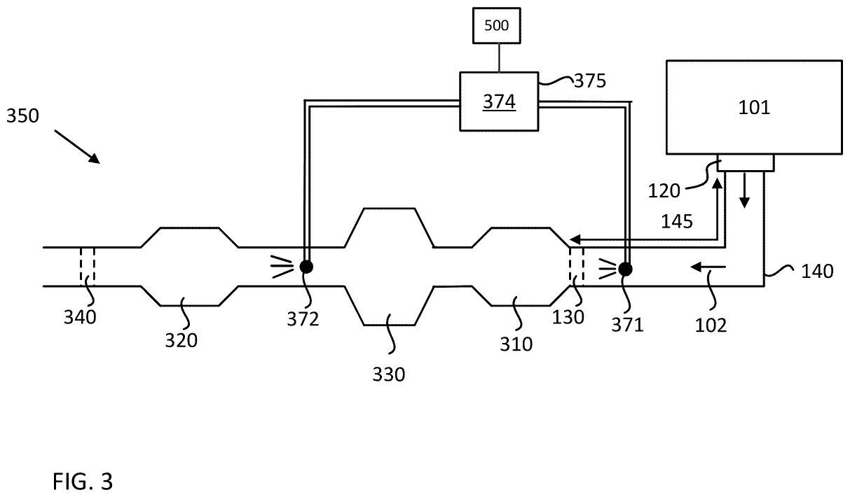

FIG. 3 schematically shows another exhaust treatment system 350, which is connected via a turbo device 120 and an exhaust conduit 140 to a combustion engine 101, e.g. an internal combustion engine. Exhausts are generated at combustion in the engine 101 and the exhaust stream 102 (indicated with arrows) are led to an upstream reductant dosing device 371, arranged to add a reductant into the exhaust stream 102. An upstream first selective catalytic reduction (SCR) catalyst 310 is arranged downstream of the upstream reductant dosing device 371. An evaporation arrangement 130 is configured at the upstream reductant dosing device 371 to increase the speed of the decomposition of urea into ammonia, and/or to mix the additive with the emissions, and/or to vaporise the additive.

The upstream first selective catalytic reduction catalyst 310 is arranged to reduce nitrogen oxides NOₓ in the exhaust stream 102, through the use of the reductant added to the exhaust stream 102 by the upstream reductant dosing device 371. In more detail, the upstream first selective catalytic reduction catalyst 310 uses the reductant, for example ammonia NH₃, or a substance from which ammonia may be generated/formed/released, for the reduction of nitrogen oxides NOₓ in the exhaust stream 102. This reductant may for example consist of the above mentioned AdBlue, and may be provided from a container/tank 375. The injection of the additive may be controlled by a control unit/system 500, e.g. configured to control one or more pumps.

Downstream of the upstream first selective catalytic reduction catalyst 310, an upstream slip catalyst may be configured.

Downstream of the upstream first selective catalytic reduction catalyst 310, the exhaust treatment system 350 further comprises a coated diesel particulate filter (cDPF) 330, which is coated with a catalytically oxidizing coating, for example comprising at least one precious metal for catching and oxidizing soot and ash. Alternatively, a diesel oxidation catalyst (DOC) followed downstream by a diesel particulate filter (DPF) 330 may be arranged in the exhaust treatment system 350 instead of the coated diesel particulate filter. Thus, either of a coated diesel particulate filter 330 and a diesel oxidation catalyst followed by a diesel particulate filter is arranged downstream of the upstream reduction catalyst device 310 in the exhaust treatment system 350.

Downstream of the particulate filter 330, the exhaust treatment system 350 comprises a downstream reductant dosing device 372, which is arranged to supply reductant to the exhaust stream 102, where such second additive comprises ammonia NH₃, or a substance, for example AdBlue, from which ammonia may be generated/formed/released, as described above. The downstream reductant may here be the same reductant as the above mentioned reductant injected by the upstream reductant dosing device 371, and may possibly also come from the same container/tank 375. Alternatively, the reductants injected by the upstream 371 and downstream 372 dosing devices, respectively, may also be of different types and may come from different tanks. The injection by the downstream dosing device 372 may be controlled by a control unit/system 500, e.g. by control of one or more pumps.

According to various embodiments of the invention, a downstream evaporation arrangement may be configured at the downstream reductant dosing device to increase the speed of the decomposition of urea into ammonia, and/or to mix the additive with the emissions, and/or to vaporise the additive.

The exhaust treatment system 350 also comprises a downstream second selective catalytic reduction catalyst 320, which is arranged downstream of the downstream reductant dosing device 372. The downstream second selective catalytic reduction catalyst 320 is arranged to reduce nitrogen oxides NOx in the exhaust stream 102 through use of the reductant injected by the downstream reductant dosing device 372, and possibly also additive remaining in the exhaust stream 102 which was injected by the upstream dosing device 371.

At least one slip catalyst 240 may be configured downstream of the downstream second selective catalytic reduction catalyst 320.

After passing through the components of the exhaust treatment system, the exhaust stream 102 is emitted into the environment at the tailpipe of the exhaust treatment system 350.

The exhaust treatment system 350 may also be equipped with one or several sensors (not shown), such as one or several NOx sensors and/or one or several temperature sensors, which are arranged for the determination of NOx-concentrations and temperatures in the exhaust treatment system 350, respectively.

Through the use of the exhaust treatment system 350 shown in FIG. 3, both the upstream first selective catalytic reduction catalyst 310 and the downstream second selective catalytic reduction catalyst 320 may be optimized with respect to a selection of catalyst characteristics for the reduction of nitrogen oxides NOx, and/or with respect to volumes for the upstream 310 and downstream 320 selective catalytic reduction catalyst, respectively.

The particulate filter 330 may hereby be used to improve the efficiency, by taking into account how its thermal mass, i.e. its thermal inertia, impacts the temperature of the downstream second selective catalytic reduction catalyst 320. By taking into account the thermal inertia of the particulate filter 330, the upstream first selective catalytic reduction catalyst 310 and the downstream second selective catalytic reduction catalyst 320, respectively, may be optimized with respect to the specific temperature function each will experience.

The exhaust treatment system 350 reduces the amount of nitrogen oxides NOx in the exhaust stream in substantially all driving modes, comprising especially cold starts and throttle, that is to say increased requested torque.

The above mentioned slip-catalyst 340 may, according to various embodiments, be a catalyst, which is arranged to oxidize additive in the exhaust stream 102, and/or which is arranged so that it is able to reduce residual nitrogen oxides NOx in the exhaust stream 102.

For both the upstream first selective catalytic reduction catalyst 310 and the downstream second selective catalytic reduction catalyst 320, its catalytic characteristics may be selected based on the environment to which it is exposed, or will be exposed to. Additionally, the catalytic characteristics for the upstream first selective catalytic reduction catalyst 310 and the downstream second selective catalytic reduction catalyst 320 may be adapted so that they may be allowed to operate in symbiosis with each other. The upstream first selective catalytic reduction catalyst 310 and the downstream second selective catalytic reduction catalyst 320 may also comprise one or several materials, providing the catalytic characteristic. For example, transition metals such as vanadium and/or tungsten may be used, for example in a catalyst comprising V₂O₅/WO₃/TiO₂. Metals such as iron and/or copper may also be comprised in the upstream 310 and/or downstream 320 reduction catalyst devices, for example in a Zeolite-based catalyst.

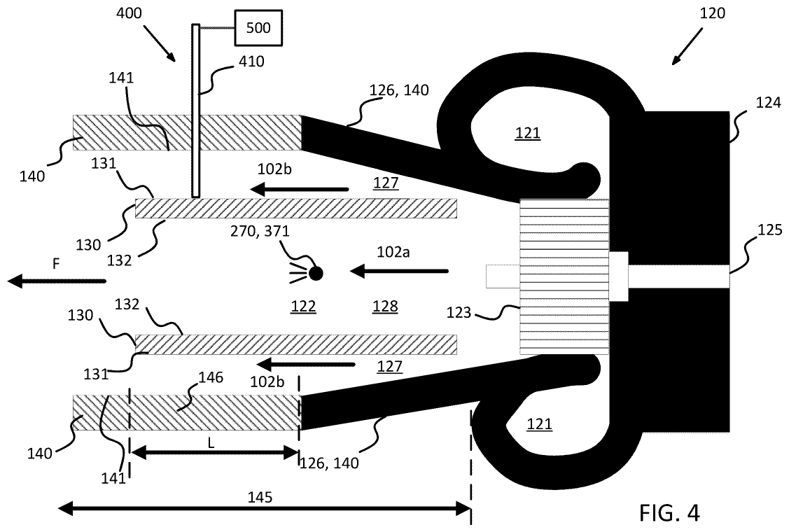

FIG. 4 schematically shows a cross section of a turbo device 120 and a part of a conduit 140 from the turbo device 120 to downstream components of the exhaust treatment system 250, 250 described above. The conduit 140 is formed by an outlet body 126 of the turbo device 120 and/or a hose and/or piping attached to the outlet body 126.

The turbo device 120 comprises a housing 124. Exhaust gas inlets 121 are formed in housing 124. An exhaust gas outlet 122 is formed by the outlet body 126 of the turbo device. The turbo device 120 comprises a turbine rotor 123 configured to rotate in the housing 124, driven by the exhausts 102 flowing through the turbo device 120. Thus, the turbo device 120 is configured to receive and interact with exhaust gases 102 output by the combustion engine 101, and is connected to a downstream component 210, 310 of an exhaust treatment system 250, 350 by an exhaust conduit 140, such that the exhaust gases 102 are output to the downstream components of the exhaust treatment system 250, 350.

A turbine rotor/wheel 123 is in operation configured to rotate together with a shaft 125 when the exhaust gases 102 flow through the turbo device 120. In embodiments in which the turbo device 120 is turbocharger, the shaft 125 is connected to a compressor. In embodiments in which the turbo device 120 is a turbo compound device, the shaft 125 may be connected to an output shaft of the combustion engine 101 or to another shaft or type of device configured to produce useful energy by the rotation of the turbine rotor 123.

An evaporator device 130, which has an annular shape, is configured radially inside of a turbo section 145 of the exhaust conduit 140. As explained more in detail below, the turbo section 145 of the exhaust conduit 140 comprises a body 126 of the turbo device 120 around an outlet 122 of the turbo device 120 and/or a portion 146 of the exhaust conduit 140 extending downstream from an outlet 122 of the turbo device 120.

The evaporator device 130 is configured radially inside of the turbo section 145 of the exhaust conduit 140, such that a first portion 102a of the exhaust gases from the combustion engine 101 flows through the evaporator device 130, i.e. flows within the annular evaporator device 130. This first portion 102a of the exhaust gases is thus mixed with a reductant 274, 374 being injected by a reductant dosing device 270, 371 configured radially inside 128 the evaporator device 130.

The evaporator device 130 is further configured radially inside of a turbo section 145 of the exhaust conduit 140, at a distance to an inner wall 141 of the exhaust conduit 140, e.g. at a distance from the outlet body 126 of the turbo device 120 and/or from the portion 146 of the exhaust conduit 140 extending downstream from an outlet 122 of the turbo device 120. Hereby, a second portion 102b of the exhaust gases flows through a passage 127 formed between an outer wall 131 of the evaporator device 130 and the inner wall 141 of the exhaust conduit 140.

According to the present invention, a heating arrangement 400 is configured to increase of a temperature Teva of a wall of the evaporator device 130, i.e. of an outer wall 131 and/or an inner wall 132 of the of the evaporator device 130, and/or a temperature T_{2nd} of the second portion 102b of the exhaust gases 102.

The heating arrangement 400 therefore comprises an electric heating device 410 configured to provide thermal energy Eth to the wall of the evaporator device 130, and/or an oxidation catalyst 420 configured to provide oxidation of hydrocarbons 431 at the oxidation catalyst 420 in the passage 127 between the evaporator device 130 and the exhaust conduit 140.

The electric heating device 410 is schematically illustrated in FIG. 4. It is configured to be in thermal contact with the wall 131, 132 of the evaporator device 130 and is configured to convert electric energy Eₑₗ to thermal energy Eₜₕ, thereby providing the created thermal energy Eth to the wall 131, 132 of the evaporator device 130 and increasing the temperature Teva of the wall 131, 132, the temperature T_{2nd} of the second portion 102b of the exhaust gases in the passage 127 between the evaporator device 130 and the conduit 140 and/or the temperature Tₜₒₜ of a mixture of the first portion 102a and the second portion 102b downstream of the evaporator device 130. The electric heating device 410 may be controlled by the herein described control unit 500.

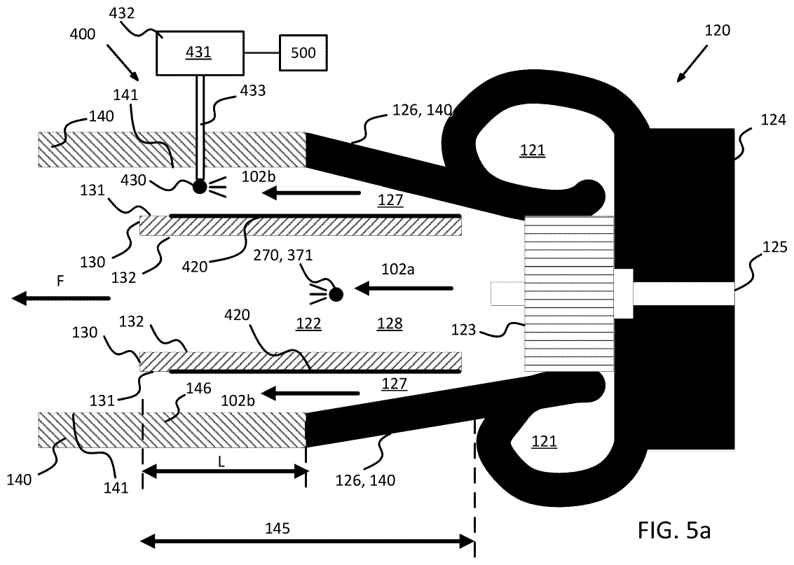

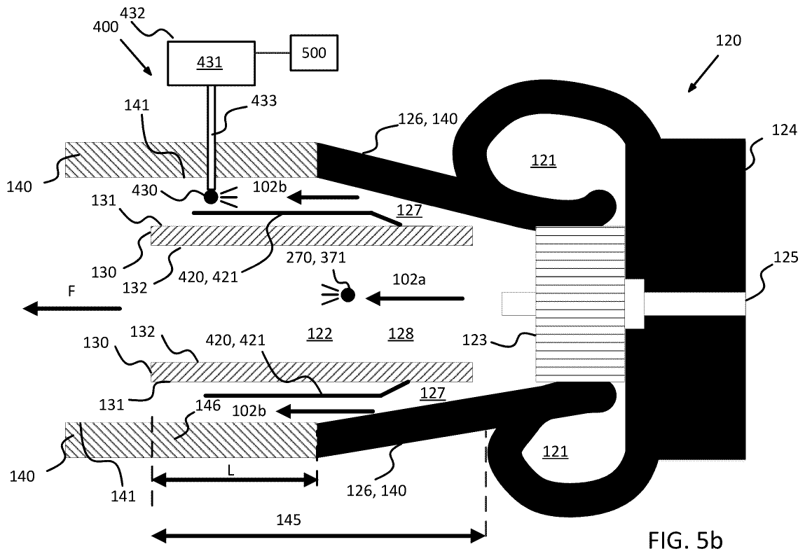

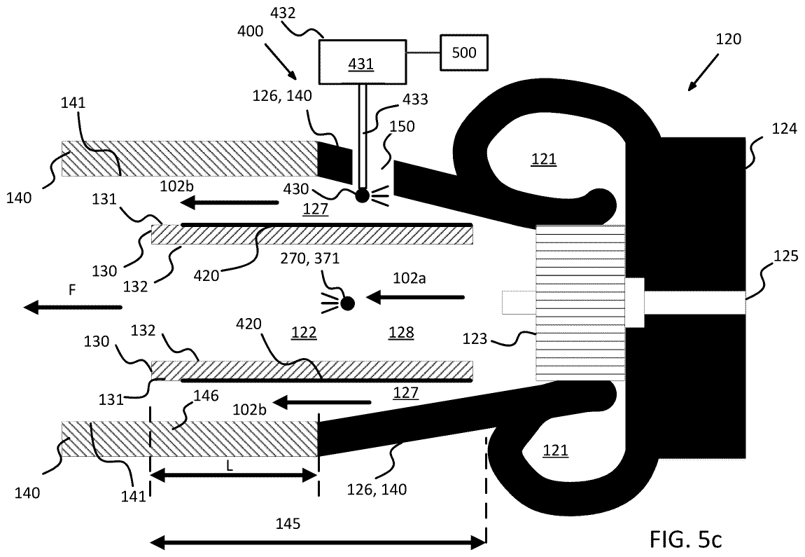

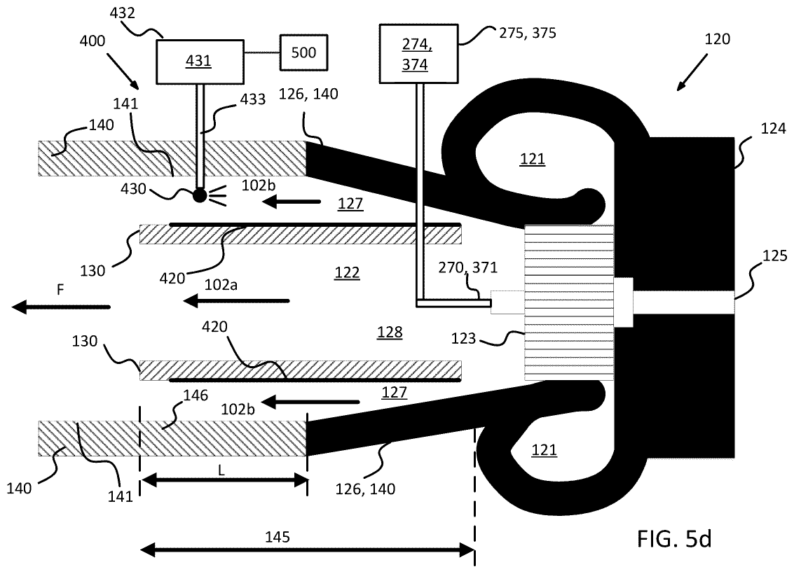

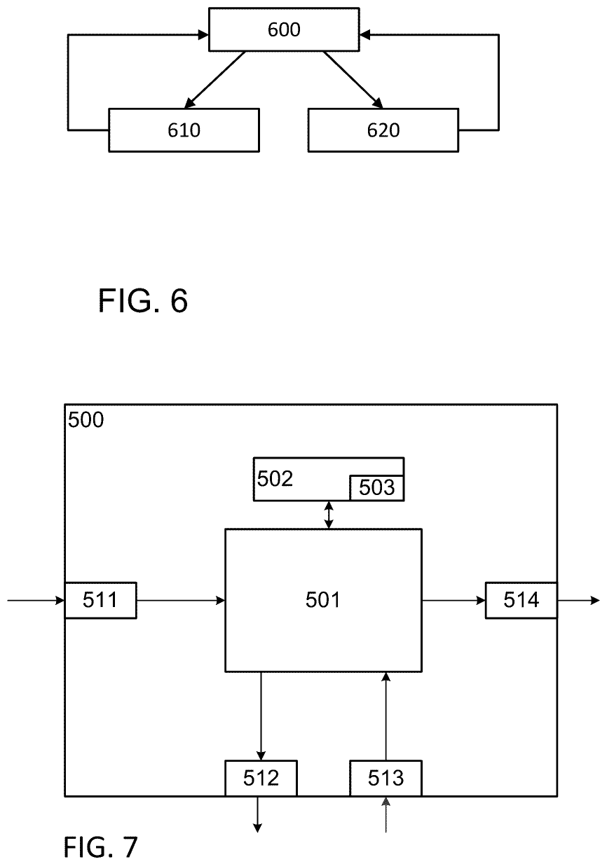

The oxidation catalyst 420 is schematically illustrated in FIGS. 5a-d for various embodiments. The oxidation catalyst 420 is configured at one or more parts of the outer wall 131 of the evaporator device 130. FIGS. 5a-d further shows the hydrocarbon dosing device 430 configured in the passage 127 between the evaporator device 130 and the conduit 140 to inject hydrocarbons 431 into the second portion 102b of the exhaust gases. Hereby, the temperature Tₑᵥₐ of the wall 131, 132 of the evaporator device 130, the temperature T_{2nd} of the second portion 102b of the exhaust gases 102 and/or the temperature Tₜₒₜ of the mixed first 102a and second 102b exhaust portions downstream of the evaporator device 130 are increased by oxidation of the hydrocarbons 431 at the oxidation catalyst 420 in the passage 127.

The hydrocarbons 431 may be stored in a hydrocarbon tank 432, and may be provided to the hydrocarbon dosing device 430 by a duct/pipe/hose 433, possibly via at least one filter and/or at least one controllable valve. A pump may be arranged to pump the hydrocarbons 431 from the tank 432 to the hydrocarbon dosing device 430. The pump and/or the valve may be controlled by the herein described control unit 500.

According to an embodiment, the heating arrangement 400 comprises all of the electric heating device 410, the oxidation catalyst 420, and the hydrocarbon dosing device 430. Such a heating arrangement 400 thus comprises the electric heating device 410 as herein disclosed and illustrated in FIG. 4. The heating arrangement 400 also comprises an oxidation catalyst 420 and hydrocarbon dosing device 430 as herein disclosed and illustrated in FIGS. 5a-d.

The electric heating device may here be utilized for increasing the temperature of the evaporator device 130 and/or the temperature of the oxidation catalyst 420. By increasing the temperature of the oxidation catalyst 420, it may be ensured that the oxidation catalyst has a temperature above a light-off temperature for the hydrocarbons, for example 200-250° C., and that an efficient heating of the evaporator device therefore is provided by the oxidation catalyst.

In FIGS. 4 and 5a-d, the evaporator device 130 has an annular shape in form of a cylindric pipe. However, the evaporator device 130 may have essentially any annular shape suitable for dividing the exhaust stream 102 in a first portion 102a flowing through/within the evaporator device 130 and a second portion 102b flowing outside of the evaporator device 130, i.e. through the passage 127 between the outer wall 131 of the evaporator device 130 and an inner wall 141 of the exhaust conduit 140. For example, the evaporator device 130 may also be formed as cone-shaped pipe having its base in a downstream flow direction F, i.e. in a downstream flow direction, thus having its base directed away from the turbine rotor 123.

As stated above, the evaporator device 130 is configured radially inside of the turbo section 145 of the exhaust conduit. The turbo section 145 of the exhaust conduit 140 here comprises the body 126 of the turbo device 120 around the outlet 122 of the turbo device 120 and/or a portion 146 of the exhaust conduit 140 extending downstream at most a length L from an outlet 122 of the turbo device 120, the length L being in an interval of 0 to 8 diameters D of the exhaust conduit 140. As a non-limiting example, the exhaust conduit may have a diameter D in an interval of 12-15 cm, which results in a length L in an interval of 0 cm to 96-120 cm.

Thus, the evaporator device 130, and the dosing device 270, 371 configured radially inside 128 the evaporator device 130, are arranged radially inside the outlet body 126 of the turbo device 120 and/or up to 8 diameters D of the exhaust conduit 140 extending downstream from the outlet 122 of the turbo device 120. The evaporator device 130 is in other words configured radially inside of the turbo section 145 of the exhaust conduit.

According to an embodiment, the evaporator device 130 extends at least partially along the turbo section 145 of the exhaust conduit 140. Thus, the evaporator device 130 may be configured to extend essentially anywhere radially inside the outlet body 126 of the turbo device 120 and/or up to 8 diameters D of the exhaust conduit 140 extending downstream from the outlet 122 of the turbo device 120. The evaporator device 130 may be configured as one piece, or as two or more pieces, and may be concentrated to one part of the turbo section 145 of the exhaust conduit 140, or may be at least partially distributed over the length of the turbo section 145 of the exhaust conduit 140.

According to an embodiment schematically illustrated in FIGS. 5a, 5c and 5d, the oxidation catalyst 420 configured on one or more parts of the outer wall 131 of the evaporator device 130. In FIGS. 5a, 5c and 5d, the oxidation catalyst 420 is configured as one piece on an upstream part of the evaporator device 130. However, the oxidation catalyst 420 may also be configured on one or more downstream parts of the evaporator device 130, i.e. may be at least partly distributed over the evaporator device 130.

According to an embodiment schematically illustrated in FIG. 5b, the oxidation catalyst 420 is configured on at least one substrate 421 arranged in the passage 127 between the evaporator device 130 and the exhaust conduit 140. The oxidation catalyst 420 is then configured to be in thermal contact with the wall of the evaporator device 131, 132. In FIG. 5b, the at least one substrate 421 is configured at an upstream part of the evaporator device 130. However, the at least one substrate 421, and thus also the oxidation catalyst 420, may also be configured at a position further downstream, i.e. may be at least partly distributed over the evaporator device 130.

According to an embodiment, the oxidation catalyst 420 has a surface enlarging form and comprises a catalytic coating. For example, the oxidation catalyst 420, and its catalytic coating, may have a rough surface, comprising one or more elevations, recesses, valleys, ridges, wrinkles, crimps and/or folds.

According to various embodiments, the hydrocarbon dosing device 430 comprises one or more nozzles configured in various positions and/or ways.

At least one nozzle may be configured such that the injected hydrocarbons 431 are prevented from reaching an inside 128 of the evaporator device 130, i.e. is configured to inject hydrocarbons 431 only into the passage 127 between the evaporator device 130 and the exhaust conduit 140.

Further, at least one nozzle may be configured in the passage 127 between the evaporator device 130 and the exhaust conduit 140, as schematically illustrated in FIGS. 5a-b and 5d.

Further, at least two nozzles may be configured in the passage 127 between the evaporator device 130 and the exhaust conduit 140, such that the at least two nozzles are distributed around a circumference of the outer wall 131 of the evaporator device 130.

Further, at least one nozzle may be configured at a waste gate outlet 150 into the passage 127 127 between the evaporator device 130 and the exhaust conduit 140, as schematically illustrated in FIG. 5c.

Further, at least one nozzle may be connected to one or more annular distribution channels configured to distribute hydrocarbon to the at least one nozzle.

Further, at least one nozzle may be connected to one or more distribution channels configured to distribute hydrocarbon to the at least one nozzle, where each distribution channel comprises at least one circular section, i.e. the distribution channels are formed as one or more pipes.

According to various embodiments schematically illustrated in FIGS. 4 and 5a-c, the reductant dosing device 270, 371 is configured downstream of the turbo device 120 within the turbo section 145 of the exhaust conduit 140. Thus, the reductant dosing device 270, 371 is here configured radially inside 128 the evaporator device 130 and downstream of the turbo device 120.

According to an embodiment schematically illustrated in FIG. 5d, however, the reductant dosing device 270, 371 is a turbo dosing device configured to distribute the reductant 274, 374 in an outlet 122 of the turbo device 120 by utilization of a rotation of the turbine rotor 123 of the turbo device 120. In operation, the reductant is provided to a distribution device configured to spin together with the turbine rotor 123 of the turbo device 120 when exhaust gas 102 passes through the turbine rotor 123. The reductant 274,374 is hereby distributed/dispersed in, i.e. mixed with, the exhaust gas 102 passing through the turbine rotor 123 by the spinning motion of the distribution device.

The heating arrangement 400 is configured to increase the temperature Tₑᵥₐ of the wall of the evaporator device 130, i.e. its inside and/or outside walls 131, 132, to increase the temperature T_{2nd} of the second portion 102b of the exhaust gases 102 in the passage 127 between the evaporator device 130 and the exhaust conduit 140 and/or to increase the total temperature Tₜₒₜ of the mixed first 102a and second 102b exhaust portions downstream of the evaporator device 130 by utilization of the electric heating device 410 shown in FIG. 4 when a temperature T_{eng} of the combustion engine 101 is below an engine temperature threshold T_{eng}_{_{_}}ₜₕ; T_{eng}<T_{eng}_{_{_}}ₜₕ. As a non-limiting example, the engine temperature threshold T_{eng}_{_{_}}ₜₕ may have a value of 80° C.

Also, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ of the mixed first 102a and second 102b exhaust portions when a temperature T_{SCR} of a selective catalytic reduction catalyst 220, 310, 320 of the exhaust treatment system 250, 350 is below a catalyst temperature threshold T_{SCR}_{_{_}}ₜₕ; T_{SCR}<T_{SCR}_{_{_}}ₜₕ. Such selective catalytic reduction catalysts 220, 310, 320 and exhaust treatment systems 250, 350 are described above, and are schematically illustrated in FIGS. 2-3. The temperature T_{SCR} of a selective catalytic reduction catalyst may here be a temperature of an upstream/initial section of the selective catalytic reduction catalyst, may be a temperature of an middle section of the selective catalytic reduction catalyst, may be a temperature of a downstream/final section of the selective catalytic reduction catalyst, and/or may be average or median temperature value based on one or more of the temperatures of the upstream/initial section, the middle section and/or the downstream/final section of the selective catalytic reduction catalyst. The temperature T_{SCR} of the selective catalytic reduction catalyst may be determined by utilization of one or more measurements and/or one or more temperature models. As a non-limiting example, the catalyst temperature threshold T_{SCR}_{_{_}}ₜₕ may have a value of 220° C.

Further, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ of the mixed first 102a and second 102b exhaust portions when the temperature Tₑᵥₐ of the wall 131, 132 of the evaporator 130 device is below an evaporator temperature threshold Tₑᵥₐ_{_{_}}ₜₕ; Tₑᵥₐ<Tₑᵥₐ_{_{_}}ₜₕ. As a non-limiting example, the evaporator temperature threshold Tₑᵥₐ_{_{_}}ₜₕ may have a value of 250° C.

Further, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ of the mixed first 102a and second 102b exhaust portions when a temperature Tₒₓ of the oxidation catalyst 420 is below an oxidation catalyst temperature threshold Tₒₓ_{_{_}}ₜₕ; Tₒₓ<Tₒₓ_{_{_}}ₜₕ. As a non-limiting example, the oxidation catalyst temperature threshold Tₒₓ_{_{_}}ₜₕ may have a value of 250° C.

Further, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ when the temperature T_{2nd} of the second portion 102b of the exhaust gases 102 is below a second portion temperature threshold T_{2nd}_{_{_}}ₜₕ; T_{2nd}<T_{2nd}_{_{_}}ₜₕ. As a non-limiting example, the second portion temperature threshold T_{2nd}_{_{_}}ₜₕ may have a value being dependent on a flow balance between the first 102a and second 102b exhaust portions.

Further, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ of the mixed first 102a and second 102b exhaust portions when the temperature Tₜₒₜ of the mixed first 102a and second 102b portions downstream of the evaporator device 130 is below a total temperature threshold Tₜₒₜ_{_{_}}ₜₕ; Tₜₒₜ<Tₜₒₜ_{_{_}}ₜₕ. As a non-limiting example, total temperature threshold Tₜₒₜ_{_{_}}ₜₕ may have a value of 220° C.

Further, the heating arrangement 400 is according to an embodiment, by utilization of the electric heating device 410, configured to increase one or more of the wall temperature Tₑᵥₐ, the second portion temperature T_{2nd}, and the total mixed temperature Tₜₒₜ when a load on the combustion engine 101 decreases.

The temperature Teng of the combustion engine 101, the temperature T_{SCR} of the selective catalytic reduction catalyst 220, 310, 320, the temperature Teva of the wall 131, 132 of the evaporator 130, the temperature Tₒₓ of the oxidation catalyst 420, the temperature T_{2nd} of the second portion 102b of the exhaust gases 102, and/or the temperature Tₜₒₜ of the mixed first 102a and second 102b exhaust portions may here be determined by one or more sensors configured to sense these temperatures, e.g. on or at the combustion engine 101, the selective catalytic reduction catalyst 220, 310, 320, the wall 131, 132 of the evaporator 130, the oxidation catalyst 420, the second portion 102b of the exhaust gases 102, and/or downstream of the evaporator device 130, respectively.

According to an embodiment, the heating arrangement 400 is configured to increase temperature Tₑᵥₐ of the wall 131, 132 of the evaporator device 130, the temperature T_{2nd} of the second portion 102b of the exhaust gases 102 in the passage 127 and/or the temperature Tₜₒₜ of the mixed first 102a and second 102b exhaust gas portions downstream of the evaporator device 130 by utilization of the oxidation of the hydrocarbons 431 at the oxidation catalyst 420 when a temperature T_{eng} of the combustion engine 101 is equal to or above an engine temperature threshold T_{eng}_{_{_}}ₜₕ; T_{eng}≥T_{eng}_{_{_}}ₜₕ. As a non-limiting example, the engine temperature threshold T_{eng}_{_{_}}ₜₕ may have a value of 80° C.

Also, the heating arrangement 400 is according to an embodiment, by utilization of the oxidation of the hydrocarbons 431 at the oxidation catalyst 420, configured to increase one or more of the wall temperature Tₑᵥₐ, the second portion temperature T_{2nd} and the temperature Tₜₒₜ of the mixed first 102a and second 102b exhaust gas portions downstream of the evaporator device 130 when a temperature T_{SCR} of a selective catalytic reduction catalyst 220, 310, 320 of the exhaust treatment system 250, 350 is equal to or above a catalyst temperature threshold T_{SCR}_{_{_}}ₜₕ; T_{SCR}≥T_{SCR}_{_{_}}ₜₕ. The temperature T_{SCR} of a selective catalytic reduction catalyst may here be a temperature of an upstream/initial section of the selective catalytic reduction catalyst, may be a temperature of an middle section of the selective catalytic reduction catalyst, may be a temperature of a downstream/final section of the selective catalytic reduction catalyst, and/or may be average or median temperature value based on one or more of the temperatures of the upstream/initial section, the middle section and/or the downstream/final section of the selective catalytic reduction catalyst. As a non-limiting example, the catalyst temperature threshold T_{SCR}_{_{_}}ₜₕ may have a value of 220° C.

Further the heating arrangement 400 is according to an embodiment, by utilization of the oxidation of the hydrocarbons 431 at the oxidation catalyst 420, configured to increase one or more of the wall temperature Tₑᵥₐ, the second portion temperature T_{2nd} and/or the temperature Tₜₒₜ of the mixed first 102a and second 102b exhaust gas portions downstream of the evaporator device 130 when the temperature Tₑᵥₐ of the wall 131, 132 of the evaporator device 130 is equal to or above an evaporator temperature threshold Tₑᵥₐ_{_{_}}ₜₕ; Tₑᵥₐ≥Tₑᵥₐ_{_{_}}ₜₕ. As a non-limiting example, the evaporator temperature threshold Tₑᵥₐ_{_{_}}ₜₕ may have a value of 250° C.

Further the heating arrangement 400 is according to an embodiment, by utilization of the oxidation of the hydrocarbons 431 at the oxidation catalyst 420, configured to increase one or more of the wall temperature Tₑᵥₐ, the second portion temperature T_{2nd} and/or the temperature Tₜₒₜ of the mixed first 102a and second 102b exhaust gas portions downstream of the evaporator device 130 when a temperature Tₒₓ of the oxidation catalyst 420 is equal to or above an oxidation catalyst temperature threshold Tₒₓ_{_{_}}ₜₕ; Tₒₓ≥Tₒₓ_{_{_}}ₜₕ. As a non-limiting example, the oxidation catalyst temperature threshold Tₒₓ_{_{_}}ₜₕ may have a value in an interval of of 250-300° C.

Further the heating arrangement 400 is according to an embodiment, by utilization of the oxidation of the hydrocarbons 431 at the oxidation catalyst 420, configured to increase one or more of the wall temperature Tₑᵥₐ, the second portion temperature T_{2nd} and/or the temperature Tₜₒₜ of the mixed first 102a and second 102b exhaust gas portions downstream of the evaporator device 130 when the temperature T_{2nd} of the second portion 102b of the exhaust gases 102 is equal to or above a second portion temperature threshold T_{2nd}_{_{_}}ₜₕ; T_{2nd}≥T_{2nd}_{_{_}}ₜₕ. As a non-limiting example, the second portion temperature threshold T_{2nd}_{_{_}}ₜₕ may have a value being dependent on a flow balance between the first 102a and second 102b exhaust portions.

Further the heating arrangement 400 is according to an embodiment, by utilization of the oxidation of the hydrocarbons 431 at the oxidation catalyst 420, configured to increase one or more of the wall temperature Tₑᵥₐ, the second portion temperature T_{2nd} and/or the temperature Tₜₒₜ of the mixed first 102a and second 102b exhaust gas portions downstream of the evaporator device 130 when when a temperature Tₜₒₜ of the mixture of the first portion 102a and the second portion 102b downstream of the evaporator device 130 is equal to or above a total temperature threshold Tₜₒₜ_{_{_}}ₜₕ; Tₜₒₜ≥Tₜₒₜ_{_{_}}ₜₕ As a non-limiting example, the total temperature threshold Tₜₒₜ_{_{_}}ₜₕ may have a value of 220° C.

The temperature T_{eng} of the combustion engine 101, the temperature T_{SCR} of the selective catalytic reduction catalyst 220, 310, 320, the temperature Tₑᵥₐ of the wall 131, 132 of the evaporator 130, the temperature Tₒₓ of the oxidation catalyst 420, the temperature T_{2nd} of the second portion 102b of the exhaust gases 102, and/or the temperature Tₜₒₜ of the mixed first 102a and second 102b exhaust gas portions downstream of the evaporator device 130 may here be determined by one or more sensors configured to sense these temperatures, e.g. on or at the combustion engine 101, the selective catalytic reduction catalyst 220, 310, 320, the wall 131, 132 of the evaporator 130, the oxidation catalyst 420, the second portion 102b of the exhaust gases 102, and/or the the mixed first 102a and second 102b exhaust gas portions downstream of the evaporator device 130, respectively.

According to an aspect, an exhaust treatment system 250, 350 configured to interact with exhaust gases 102 output from a combustion engine 101 is presented above, and is schematically illustrated in FIGS. 2-3. The exhaust treatment system 250, 350 comprises a herein disclosed evaporator device 130 and a herein disclosed a heating arrangement 400.

For the exhaust treatment system 250 disclosed in connection with FIG. 2, which comprises one selective catalytic reduction catalyst 220, the reductant dosing device 270, the evaporator device 130, and the herein presented heating arrangement 400 are all configured upstream of the selective catalytic reduction catalyst 220, and more particular upstream of the particulate filter 210.

For the exhaust treatment system 350 disclosed in connection with FIG. 3, which comprises a first selective catalytic reduction catalyst 310 and a second selective catalytic reduction catalyst 320 arranged downstream of the first selective catalytic reduction catalyst 310, the reductant dosing device 371, the evaporator device 130, and the heating arrangement 400 are all configured upstream of the first selective catalytic reduction catalyst 310.

According to an aspect of the present invention, a method 600 for heating an evaporator device 130 configured downstream of a turbine rotor 123 of a turbo device 120 is provided.

As explained above, the turbo device 120 is configured at a combustion engine 101 to receive and interact with exhaust gases 102 output by the combustion engine 102, and is connected to a downstream component 210, 310 of an exhaust treatment system 250, 350 by an exhaust conduit 140.

The evaporator device 130 has an annular shape and is configured radially inside of a turbo section 145 of the exhaust conduit, such that a first portion 102a of the exhaust gases flows through the evaporator device 130 and is mixed with a reductant 274, 374 being injected by a reductant dosing device 270, 371 configured radially inside 128 the evaporator device 130. The configuration of the evaporator device 130 also causes a second portion 102b of the exhaust gases to flow through a passage 127 formed between an outer wall 131 of the evaporator device 130 and an inner wall 141 of the exhaust conduit 140.

In a first step 610 of the method 600, one or more of a temperature Tₑᵥₐ of a wall 131, 132 of the evaporator device 130, a temperature T_{2nd} of the second portion 102b of the exhaust gases 102, and a temperature Tₜₒₜ of a mixture of the first portion 102a and the second portion 102b downstream of the evaporator device 130 are increased by utilization of an electric heating device 410 being configured to convert electric energy Eₑₗ to thermal energy Eₜₕ and to provide the thermal energy Eₜₕ to the wall 131, 132 of the evaporator device 130.

According to various embodiments, the first step 610 is performed in one or more of the following situations:
when a temperature T_{eng} of the combustion engine 101 is below the engine temperature threshold T_{eng}_{_{_}}ₜₕ defined above; T_{eng}<T_{eng}_{_{_}}ₜₕ;
when a temperature T_{SCR} of a selective catalytic reduction catalyst of the exhaust treatment system 250, 350 is below the catalyst temperature threshold T_{SCR}_{_{_}}ₜₕ defined above; T_{SCR}<T_{SCR}_{_{_}}ₜₕ;
when the temperature Tₑᵥₐ of the wall 131, 132 of the evaporator device is below the evaporator temperature threshold Tₑᵥₐ_{_{_}}ₜₕ defined above; Tₑᵥₐ<Tₑᵥₐ_{_{_}}ₜₕ;
when a temperature Tₒₓ of the oxidation catalyst 420 is below the oxidation catalyst temperature threshold Tₒₓ_{_{_}}ₜₕ defined above; Tₒₓ<Tₒₓ_{_{_}}ₜₕ;
when the temperature T_{2nd} of the second portion 102b of the exhaust gases 102 is below the second portion temperature threshold T_{2nd}_{_{_}}ₜₕ defined above; T_{2nd}<T_{2nd}_{_{_}}ₜₕ;
when the temperature Tₜₒₜ of the mixture of the first portion 102a and the second portion 102b downstream of the evaporator device 130 is below the total temperature threshold Tₜₒₜ_{_{_}}ₜₕ defined above; Tₜₒₜ<Tₜₒₜ_{_{_}}ₜₕ; and
when a load on the combustion engine 101 decreases.

In a second step 620 of the method 600, one or more of a temperature Tₑᵥₐ of the a wall 131, 132 of the evaporator device 130, a temperature T_{2nd} of the second portion 102b of the exhaust gases 102, and a temperature Tₜₒₜ of a mixture of the first portion 102a and the second portion 102b downstream of the evaporator device 130 are increased by utilization of an oxidation catalyst 420 configured at one or more parts of the outer wall 131 of the evaporator device 130, and a hydrocarbon dosing device 430 configured in the passage 127 to inject hydrocarbons 431 into the second portion 102b of the exhaust gases, such that the hydrocarbons 431 are oxidized at the oxidation catalyst 420 in the passage 127.

According to various embodiments, the second step 620 is performed in one or more of the following situations:
when a temperature T_{eng} of the combustion engine 101 is equal to or above the engine temperature threshold T_{eng}_{_{_}}ₜₕ defined above; T_{eng}≥T_{eng}_{_{_}}ₜₕ;
when a temperature T_{SCR} of a selective catalytic reduction catalyst 220, 310, 320 of the exhaust treatment system 250, 350 is equal to or above the catalyst temperature threshold T_{SCR}_{_{_}}ₜₕ defined above; T_{SCR}≥T_{SCR}_{_{_}}ₜₕ; and
when the temperature Tₑᵥₐ of the wall 131, 132 of the evaporator device is equal to or above the evaporator temperature threshold Tₑᵥₐ_{_{_}}ₜₕ defined above; Tₑᵥₐ≥Tₑᵥₐ_{_{_}}ₜₕ;
when a temperature Tₒₓ of the oxidation catalyst 420 is equal to or above the oxidation catalyst temperature threshold Tₒₓ_{_{_}}ₜₕ defined above; Tₒₓ≥Tₒₓ_{_{_}}ₜₕ;
when the temperature T_{2nd} of the second portion 102b of the exhaust gases 102 is equal to or above the second portion temperature threshold T_{2nd}_{_{_}}ₜₕ defined above; T_{2nd}≥T_{2nd}_{_{_}}ₜₕ; and
when the temperature Tₜₒₜ of the mixture of the first portion 102a and the second portion 102b downstream of the evaporator device 130 is equal to or above the total temperature threshold Tₜₒₜ_{_{_}}ₜₕ defined above; Tₜₒₜ≥Tₜₒₜ_{_{_}}ₜₕ.

The method 600 may perform one or more of the first 610 and second 620 steps, and may perform the first 610 and second 620 steps in parallel, i.e. simultaneously.

A person skilled in the art will realize that a method for treatment of an exhaust stream according to the present invention may also be implemented in a computer program, which when executed in a computer will cause the computer to execute the method. The computer program usually forms a part of a computer program product 503, wherein the computer program product comprises a suitable digital non-volatile/permanent/persistent/durable storage medium on which the computer program is stored. Said non-volatile/permanent/persistent/durable computer readable medium consists of a suitable memory, e.g.: ROM (Read-Only Memory), PROM (Programmable Read-Only Memory), EPROM (Erasable PROM), Flash, EEPROM (Electrically Erasable PROM), a hard disk device, etc.

FIG. 7 schematically shows a control unit/device 500. The control device 500 comprises a calculation unit 501, which may consist of essentially a suitable type of processor or microcomputer, e.g. a circuit for digital signal processing (Digital Signal Processor, DSP), or a circuit with a predetermined specific function (Application Specific Integrated Circuit, ASIC). The calculation unit 501 is connected to a memory unit 502, installed in the control device 500, providing the calculation device 501 with e.g. the stored program code and/or the stored data, which the calculation device 501 needs in order to be able to carry out calculations. The calculation unit 501 is also set up to store interim or final results of calculations in the memory unit 502.

Further, the control device 500 is equipped with devices 511, 512, 513, 514 for receiving and sending of input and output signals, respectively. These input and output signals may contain wave shapes, pulses, or other attributes, which may be detected as information by the devices 511, 513 for the receipt of input signals, and may be converted into signals that may be processed by the calculation unit 501. These signals are then provided to the calculation unit 501. The devices 512, 514 for sending output signals are arranged to convert the calculation result from the calculation unit 501 into output signals for transfer to other parts of the vehicle's control system, and/or the component(s) for which the signals are intended.

Each one of the connections to the devices for receiving and sending of input and output signals may consist of one or several of a cable; a data bus, such as a CAN (Controller Area Network) bus, a MOST (Media Oriented Systems Transport) bus, or any other bus configuration; or of a wireless connection.

A person skilled in the art will realize that the above-mentioned computer may consist of the calculation unit 501, and that the above-mentioned memory may consist of the memory unit 502.

Generally, control systems in modern vehicles consist of a communications bus system, consisting of one or several communications buses to connect a number of electronic control devices (ECUs), or controllers, and different components localized on the vehicle. Such a control system may comprise a large number of control devices, and the responsibility for a specific function may be distributed among more than one control device. Vehicles of the type shown, thus often comprise significantly more control devices than what is shown in FIGS. 1-5 and 7, which is well known to a person skilled in the art within the technology area.

As a person skilled in the art will realize, the control device 500 in FIG. 7 may comprise or be comprised in one or several of the control devices of FIGS. 1-5 and 7, respectively.

The present invention, in the embodiment shown, is implemented in the control device 500. The invention may, however, also be implemented wholly or partly in one or several other control devices, already existing in the vehicle, or in a control device dedicated to the present invention.

The herein disclosed aspects and embodiments of the present invention may be implemented by the one or more herein mentioned control units or processing arrangements 500. The invention can also, however, be implemented wholly or partially in one or more other control units already present in the vehicle, or in some control unit dedicated to the present invention.

Here and in this document, control units, control entities or processing arrangements are sometimes described as being arranged for performing the methods and/or steps 610, 620 according to the invention. This also includes that the units, entities or processing arrangements are designed to and/or configured to perform these method steps.

One or more control entities 810, 820 may be arranged for performing the methods and/or steps. Such entities 810, 820 may be arranged as separate entities, or may be logically separated but physically implemented in the same unit, or may be both logically and physically arranged together. These control entities 810, 820 may for example correspond to groups of instructions, which can be in the form of programming code, that are input into, and are utilized by a processor/computing unit 501 when the entities are active and/or are utilized for performing its method steps, respectively.

A person skilled in the art will also realize that the above exhaust treatment system may be modified according to the different embodiments of the method according to the invention. In addition, the invention relates to the motor vehicle 100, for example a car, a truck or a bus, or another unit comprising at least one exhaust treatment system according to the invention, such as for example a vessel.

The present invention is not limited to the embodiments of the invention described above, but relates to and comprises all embodiments within the scope of the enclosed independent claims.

1. A heating arrangement for an evaporator device configured downstream of a turbine rotor of a turbo device, wherein
the turbo device is configured at a combustion engine to receive and interact with exhaust gases output by the combustion engine, and is connected to a downstream component of an exhaust treatment system by an exhaust conduit;
the evaporator device has an annular shape and is configured radially inside of a turbo section of the exhaust conduit, such that
a first portion of the exhaust gases flows through the evaporator device and is mixed with a reductant being injected by a reductant dosing device configured radially inside the evaporator device and
a second portion of the exhaust gases flows through a passage formed between an outer wall of the evaporator device and an inner wall of the exhaust conduit; and
wherein the heating arrangement comprises one or more in the group of:
an electric heating device configured to increase one or more of a temperature Tₑᵥₐ of a wall of the evaporator device, a temperature T_{2nd} of the second portion of the exhaust gases, and a temperature Tₜₒₜ of a mixture of the first portion and the second portion downstream of the evaporator device by converting electric energy Eₑₗ to thermal energy Eₜₕ and providing the thermal energy Eₜₕ to the wall of the evaporator device; and/or
an oxidation catalyst configured at one or more parts of the outer wall of the evaporator device, and a hydrocarbon dosing device configured in the passage to inject hydrocarbons into the second portion of the exhaust gases, such that one or more of a temperature Tₑᵥₐ of a wall of the evaporator device, a temperature T_{2nd} of the second portion of the exhaust gases, and a temperature Tₜₒₜ of a mixture of the first portion and the second portion downstream of the evaporator device are increased by oxidation of the hydrocarbons at the oxidation catalyst in the passage.

2. The heating arrangement as claimed in claim 1, wherein the annular shape of the evaporator device is formed by one or more in the group of:
a cylindric pipe; and/or
a cone-shaped pipe having its base in a downstream direction F.

3. The heating arrangement as claimed in claim 1, wherein the turbo section of the exhaust conduit comprises one or more in the group of:
a body of the turbo device around an outlet of the turbo device; and/or
a portion of the exhaust conduit extending downstream at most a length from an outlet of the turbo device, said length L being in an interval of 0 to 8 diameters of the exhaust conduit.

4. The heating arrangement as claimed in claim 1, wherein the evaporator device extends at least partially along the turbo section of the exhaust conduit.

5. The heating arrangement as claimed in claim 1, wherein the oxidation catalyst comprises one or more in the group of:
an oxidation catalyst configured on one or more parts of the outer wall of the evaporator device; and/or
an oxidation catalyst configured on at least one substrate arranged in the passage and in thermal contact with the wall of the evaporator device.

6. The heating arrangement as claimed in claim 1, wherein the oxidation catalyst has a surface enlarging form and comprises a catalytic coating.

7. The heating arrangement as claimed in claim 1, wherein the reductant dosing device is a turbo dosing device configured to distribute the reductant in an outlet of the turbo device by utilization of a rotation of the turbine rotor of the turbo device.

8. The heating arrangement as claimed in claim 1, wherein the reductant dosing device is configured downstream of the turbo device within the turbo section of the exhaust conduit.

9. The heating arrangement as claimed in claim 1, wherein the hydrocarbon dosing device comprises one or more in the group of:
at least one nozzle configured such that the injected hydrocarbons are prevented from reaching an inside of the evaporator device;
at least one nozzle configured in the passage;
at least two nozzles configured in the passage and distributed around a circumference of the outer wall of the evaporator device;
at least one nozzle configured at a waste gate outlet into the passage;
at least one nozzle connected to one or more annular distribution channels configured to distribute hydrocarbon to the at least one nozzle; and/or
at least one nozzle connected to one or more distribution channels configured to distribute hydrocarbon to the at least one nozzle, each distribution channel comprising at least one circular section.

10. The heating arrangement as claimed in clam 1, wherein the heating arrangement comprises all of the electric heating device, the oxidation catalyst, and the hydrocarbon dosing device.

11. The heating arrangement as claimed in claim 1, wherein the heating arrangement is configured to increase one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the electric heating device in one or more situations in the group of:
when a temperature T_{eng} of the combustion engine is below an engine temperature threshold T_{eng}_{_{_}}ₜₕ; T_{eng}<T_{eng}_{_{_}}ₜₕ;
when a temperature T_{SCR} of a selective catalytic reduction catalyst of the exhaust treatment system is below a catalyst temperature threshold T_{SCR}_{_{_}}ₜₕ, T_{SCR}<T_{SCR}_{_{_}}ₜₕ;
when the temperature Tₑᵥₐ of the wall of the evaporator device is below an evaporator temperature threshold Tₑᵥₐ_{_{_}}ₜₕ; Tₑᵥₐ<Tₑᵥₐ_{_{_}}ₜₕ;
when a temperature Tₒₓ of the oxidation catalyst is below an oxidation catalyst temperature threshold Tₒₓ_{_{_}}ₜₕ; Tₒₓ<Tₒₓ_{_{_}}ₜₕ;
when the temperature T_{2nd} of the second portion of the exhaust gases is below a second portion temperature threshold T_{2nd}_{_{_}}ₜₕ; T_{2nd}<T_{2nd}_{_{_}}ₜₕ;
when the temperature Tₜₒₜ of the mixture of the first portion and the second portion downstream of the evaporator device is below a total temperature threshold Tₜₒₜ_{_{_}}ₜₕ; Tₜₒₜ<Tₜₒₜ_{_{_}}ₜₕ; and/or
when a load on the combustion engine decreases.

12. The heating arrangement as claimed in claim 1, wherein the heating arrangement is configured to increase one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the oxidation of the hydrocarbons at the oxidation catalyst in one or more situations in the group of:
when a temperature T_{eng} of the combustion engine is equal to or above an engine temperature threshold T_{eng}_{_{_}}ₜₕ; T_{eng}≥T_{eng}_{_{_}}ₜₕ;
when a temperature T_{SCR} of a selective catalytic reduction catalyst of the exhaust treatment system is equal to or above a catalyst temperature threshold T_{SCR}_{_{_}}ₜₕ; T_{SCR}≥T_{SCR}_{_{_}}ₜₕ; and
when the temperature Tₑᵥₐ of the wall of the evaporator device is equal to or above an evaporator temperature threshold Tₑᵥₐ_{_{_}}ₜₕ; Tₑᵥₐ≥Tₑᵥₐ_{_{_}}ₜₕ;
when a temperature Tₒₓ of the oxidation catalyst is equal to or above an oxidation catalyst temperature threshold Tₒₓ_{_{_}}ₜₕ; Tₒₓ≥Tₒₓ_{_{_}}ₜₕ;
when the temperature T_{2nd} of the second portion of the exhaust gases is equal to or above a second portion temperature threshold T_{2nd}_{_{_}}ₜₕ; T_{2nd}≥T_{2nd}_{_{_}}ₜₕ; and/or
when the temperature Tₜₒₜ of the mixture of the first portion and the second portion downstream of the evaporator device is equal to or above a total temperature threshold Tₜₒₜ_{_{_}}ₜₕ; Tₜₒₜ≥Tₜₒₜ_{_{_}}ₜₕ.

13. The heating arrangement as claimed in claim 1, wherein:
the exhaust treatment system comprises a first selective catalytic reduction catalyst and a second selective catalytic reduction catalyst arranged downstream of the first selective catalytic reduction catalyst; and
the reductant dosing device, the evaporator device, and the heating arrangement are configured upstream of the first selective catalytic reduction catalyst.

14. The heating arrangement as claimed in claim 1, wherein:
the exhaust treatment system comprises one selective catalytic reduction catalyst; and
the reductant dosing device, the evaporator device, and the heating arrangement are configured upstream of the selective catalytic reduction catalyst.

15. An exhaust treatment system configured to interact with exhaust gases output from a combustion engine, the exhaust treatment system comprising:
an evaporator device; and
a heating arrangement as claimed in claim 1.

16. A vehicle comprising:
a combustion engine;
an exhaust treatment system configured to interact with exhaust gases output from the combustion engine, the exhaust treatment system comprising:
an evaporator device; and
a heating arrangement as claimed in claim 1.

17. A method for heating an evaporator device configured downstream of a turbine rotor of a turbo device; wherein
the turbo device is configured at a combustion engine to receive and interact with exhaust gases output by the combustion engine, and is connected to a downstream component of an exhaust treatment system by an exhaust conduit; and
the evaporator device has an annular shape and is configured radially inside of a turbo section of the exhaust conduit, such that
a first portion of the exhaust gases flows through the evaporator device and is mixed with a reductant being injected by a reductant dosing device configured radially inside the evaporator device and
a second portion of the exhaust gases flows through a passage formed between an outer wall of the evaporator device and an inner wall of the exhaust conduit;
the method comprising one or more steps in the group of:
increasing one or more of a temperature Tₑᵥₐ of a wall of the evaporator device a temperature T_{2nd} of the second portion of the exhaust gases, and a temperature Tₜₒₜ of a mixture of the first portion and the second portion downstream of the evaporator device by utilization of an electric heating device being configured to convert electric energy Eₑₗ to thermal energy Eₜₕ and to provide the thermal energy Eₜₕ to the wall of the evaporator device; and/or
increasing one or more of a temperature Tₑᵥₐ of the a wall of the evaporator device, a temperature T_{2nd} of the second portion of the exhaust gases, and a temperature Tₜₒₜ of a mixture of the first portion and the second portion downstream of the evaporator device by utilization of an oxidation catalyst configured at one or more parts of the outer wall of the evaporator device, and a hydrocarbon dosing device configured in the passage to inject hydrocarbons into the second portion of the exhaust gases, such that the hydrocarbons are oxidized at the oxidation catalyst in the passage.

18. The method as claimed in claim 17, wherein the increase of one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the electric heating device is performed in one or more situations in the group of:
when a temperature T_{eng} of the combustion engine is below an engine temperature threshold T_{eng}_{_{_}}ₜₕ; T_{eng}<T_{eng}_{_{_}}ₜₕ;
when a temperature T_{SCR} of a selective catalytic reduction catalyst of the exhaust treatment system is below a catalyst temperature threshold T_{SCR}_{_{_}}ₜₕ; T_{SCR}<T_{SCR}_{_{_}}ₜₕ;
when the temperature Tₑᵥₐ of the wall of the evaporator device is below an evaporator temperature threshold Tₑᵥₐ_{_{_}}ₜₕ; Tₑᵥₐ<Tₑᵥₐ_{_{_}}ₜₕ;
when a temperature Tₒₓ of the oxidation catalyst is below an oxidation catalyst temperature threshold Tₒₓ_{_{_}}ₜₕ; Tₒₓ<Tₒₓ_{_{_}}ₜₕ;
when the temperature T_{2nd} of the second portion of the exhaust gases is below a second portion temperature threshold T_{2nd}_{_{_}}ₜₕ; T_{2nd}<T_{2nd}_{_{_}}ₜₕ;
when the temperature Tₜₒₜ of the mixture of the first portion and the second portion downstream of the evaporator device is below a total temperature threshold Tₜₒₜ_{_{_}}ₜₕ; Tₜₒₜ<Tₜₒₜ_{_{_}}ₜₕ; and/or
when a load on the combustion engine decreases.

19. The method as claimed in claim 17, wherein the increase of one or more of the temperature Tₑᵥₐ of the wall of the evaporator device, the temperature T_{2nd} of the second portion of the exhaust gases, and the temperature Tₜₒₜ of the mixture of the first portion and the second portion downstream of the evaporator device by utilization of the oxidation of the hydrocarbons at the oxidation catalyst is performed in one or more situations in the group of:
when a temperature T_{eng} of the combustion engine is equal to or above an engine temperature threshold T_{eng}_{_{_}}ₜₕ; T_{eng}≥T_{eng}_{_{_}}ₜₕ;
when a temperature T_{SCR} of a selective catalytic reduction catalyst of the exhaust treatment system is equal to or above a catalyst temperature threshold T_{SCR}_{_{_}}ₜₕ, T_{SCR}≥T_{SCR}_{_{_}}ₜₕ; and
when the temperature Tₑᵥₐ of the wall of the evaporator device is equal to or above an evaporator temperature threshold Tₑᵥₐ_{_{_}}ₜₕ; Tₑᵥₐ≥Tₑᵥₐ_{_{_}}ₜₕ;
when a temperature Tₒₓ of the oxidation catalyst is equal to or above an oxidation catalyst temperature threshold Tₒₓ_{_{_}}ₜₕ; Tₒₓ≥Tₒₓ_{_{_}}ₜₕ;
when the temperature T_{2nd} of the second portion of the exhaust gases is equal to or above a second portion temperature threshold T_{2nd}_{_{_}}ₜₕ; T_{2nd}≥T_{2nd}_{_{_}}ₜₕ; and/or
when the temperature Tₜₒₜ of the mixture of the first portion and the second portion downstream of the evaporator device is equal to or above a total temperature threshold Tₜₒₜ_{_{_}}ₜₕ; Tₜₒₜ≥Tₜₒₜ_{_{_}}ₜₕ.

20. A computer program product stored on a non-transitory computer-readable medium, said computer program product for heating an evaporator device configured downstream of a turbine rotor of a turbo device, wherein the turbo device is configured at a combustion engine to receive and interact with exhaust gases output by the combustion engine, and is connected to a downstream component of an exhaust treatment system by an exhaust conduit; and the evaporator device has an annular shape and is configured radially inside of a turbo section of the exhaust conduit, such that a first portion of the exhaust gases flows through the evaporator device and is mixed with a reductant being injected by a reductant dosing device configured radially inside the evaporator device; and a second portion of the exhaust gases flows through a passage formed between an outer wall of the evaporator device and an inner wall of the exhaust conduit, wherein said computer program product comprising computer instructions to cause a computer to perform the one or more of the following operations:
increasing one or more of a temperature Tₑᵥₐ of a wall of the evaporator device, a temperature T_{2nd} of the second portion of the exhaust gases, and a temperature Tₜₒₜ of a mixture of the first portion and the second portion downstream of the evaporator device by utilization of an electric heating device being configured to convert electric energy Eₑₗ to thermal energy Eₜₕ and to provide the thermal energy Eₜₕ to the wall of the evaporator device; and/or
increasing one or more of a temperature Tₑᵥₐ of the a wall of the evaporator device, a temperature T_{2nd} of the second portion of the exhaust gases, and a temperature Tₜₒₜ of a mixture of the first portion and the second portion downstream of the evaporator device by utilization of an oxidation catalyst configured at one or more parts of the outer wall of the evaporator device, and a hydrocarbon dosing device configured in the passage to inject hydrocarbons into the second portion of the exhaust gases, such that the hydrocarbons are oxidized at the oxidation catalyst in the passage.

21. (canceled)
